(19) United States
(12) Patent Application Publication
(10) Pub. No.: US 2016/0216885 A1
(43) Pub. Date: Jul. 28, 2016

(54) METHOD AND DEVICE FOR PROCESSING TOUCH OPERATION OF ELECTRONIC APPARATUS

(71) Applicants: BEIJING QIHOO TECHNOLOGY COMPANY LIMITED, Beijing (CN); QIZHI SOFTWARE (BEIJING) COMPANY LIMITED, Beijing (CN)

(72) Inventor: Guofeng FAN, Beijing (CN)

(21) Appl. No.: 14/916,840

(22) PCT Filed: Jul. 25, 2014
(86) PCT No.: PCT/CN2014/083057

§ 371 Date: Mar. 4, 2016

(30) Foreign Application Priority Data
Sep. 4, 2013 (CN) 201310398281.6

(51) Int. Cl. G06F 3/0488; G06F 3/0484

(52) U.S. Cl. CPC G06F 3/04883; G06F 3/04845

(57) ABSTRACT

Disclosed are method and device for processing touch operation of electronic apparatus. The method comprises: receiving a sliding touch operation of the electronic apparatus; obtaining a status value of touch mode object of webpage display control; executing a first processing in the case that the status value is first status value; and executing a second processing in the case that the status value is second status value. The device comprises: a touch interface, configurable to receive a sliding touch operation of the electronic apparatus; a status value obtaining module, configurable to obtain a status value of a touch mode object of a webpage display control; a first processing module, configurable to execute a first processing in the case that the status value is a first status value; and a second processing module, configurable to execute a second processing in the case that status value is a second status value.

### CROSS-REFERENCE TO RELATED APPLICATIONS

This application is a continuation of International Application No. PCT/CN2014/083057, filed Jul. 25, 2014, which is based upon and claims priority to Chinese Patent Application No. CN201310398281.6 filed Sep. 4, 2013, the entire contents of all of which are incorporated herein by reference.

### FIELD OF TECHNOLOGY

The present disclosure generally relates to the field of touch operation technologies, and more particularly, to a method and a device for processing a touch operation of an electronic apparatus.

### BACKGROUND

Recently, gesture operations are more and more widely used on a variety of electronic apparatus with touch screens. For example, a left/right sliding on the touch screen may realize a forward/backward operational function of an application, and a webpage zoom may be available by a pinch-action. Compared to the traditional “click” touch operation, the gesture operations have greatly enriched operation means and increased operation efficiency.

When a user performs a sliding gesture operation on a webpage which is rendered on a screen of an electronic apparatus by an application, how to exactly determine the purpose of current operation of the user has become a crucial problem. In other words, the user is dragging the draggable contents in the webpage or making a sliding gesture operation to realize a relevant function (for example, forward or backward of the program).

FIG. 1 schematically illustrates a webpage interface displayed on a screen of an electronic apparatus through an application. Contents in FIG. 1 can be divided into two parts by a box 10′, the two parts are the contents inside the box 20′ and the contents outside the box 30′. The contents inside the box 20′ are a picture show in the form of slides. The user can switch different pictures by dragging the pictures. In contrast, the regions outside the box 30′ are non-draggable regions. When the user touches and slides in the box, the application does not respond to the gesture operation. This is because the user is more likely to switch the pictures. In contrast, when the user touches and slides outside the box 30′, there is a need to process the user's gesture operation, for example, to switch to the previous or subsequent webpage. In addition to the instance as shown in FIG. 1, many examples of the draggable contents inside the box 20′ can be also provided, such as electronic map, progress bar of video, etc.

There is a technical problem in the implementation of this scheme, that is interfaces provided in an operating system of the electronic apparatus do not include an interface used to judge whether contents in a region are draggable and the application cannot obtain types of contents in a region of the webpage through the existing interfaces.

Taking Android system as an example, the interface provided by browser architecture of this system has a strong limitation, so that some browser applications (such as UC browser and QQ browser) attach respective browser kernels to the installation packages thereof rather than using a native Webkit kernel of the Android system. The browsers having kernels built in are able to realize an ability to identify webpage contents corresponding to a sliding region of the user's gesture by amending and expending their own kernels, but at the cost of high technical threshold, large installation package and heavy kernel maintenance overhead. The browsers having kernels built in are normally formed by secondary development and re-packaging of the Webkit kernel. The kernels alone may have a size of about 10 MB, which causes an increased burden on the user's download and installation. As the Webkit version is updated, updating their built-in kernels to a latest version may bring significant developing expense.

### SUMMARY

In the view of above problems, the disclosure is proposed to provide a method for processing a touch operation of an electronic apparatus and a corresponding device for processing a touch operation of an electronic apparatus, for overcoming or at least partially solving above problems.

According to an aspect of the disclosure, there is provided a method for processing a touch operation of an electronic apparatus, comprising steps of: receiving a sliding touch operation of the electronic apparatus; obtaining a status value of a touch mode object of a webpage display control; executing a first processing in the case that the status value is a first status value; and executing a second processing in the case that the status value is a second status value.

According to another aspect of the disclosure, there is provided a device for processing a touch operation of an electronic apparatus, comprising: a touch interface, configurable to receive a sliding touch operation of the electronic apparatus; a status value obtaining module, configurable to obtain a status value of a touch mode object of a webpage display control; a first processing module, configurable to execute a first processing in the case that the status value is a first status value; and a second processing module, configurable to execute a second processing in the case that status value is a second status value.

According to still another aspect of the disclosure, there is provided a computer program, including computer readable codes, wherein when the computer readable codes are carried out on an electronic apparatus, the electronic apparatus executes the method for processing the touch operation of the electronic apparatus according to any one of claims 1-7.

According to still another aspect of the disclosure, there is provided a computer readable medium, in which the computer program according to claim 15 is stored.

Advantageous effects of the disclosure are as follows:

The disclosure provides above method and device for processing the touch operation of the electronic apparatus. According to the embodiment of the disclosure, it is possible to receive the sliding touch operation of the electronic apparatus and to obtain the status value of the touch mode object of the webpage display control; in the case that the status value is first status value, to execute the first processing; and in the case that the status value is second status value, to execute the second processing. Thereby, it is possible to exactly judge characteristics of a region (for example, whether it is a region where the webpage contents cannot be dragged or a region where the webpage contents can be dragged) according to the status value reflecting the region where the sliding touch operation occurs and to execute the processing corresponding to the region, so as to effectively eliminate the shortage that a processing is completed contrary to the purpose of the user's sliding touch operation since it is hard to distinguish regions in the page having different characteristics in the prior art. In the meanwhile, since there is no need to change a kernel component of a browser or other page display program, it is possible to directly use various characteristics of operating system having new version without re-development, while avoiding a security risk introduced by amending the kernel component. In addition, since there is no individual built-in kernel component, the memory space of the electronic apparatus can be saved.

Described above is merely an overview of the inventive scheme. In order to more apparently understand the technical means of the disclosure to implement in accordance with the contents of specification, and to more readily understand above and other objectives, features and advantages of the disclosure, specific embodiments of the disclosure are provided hereinafter.

### BRIEF DESCRIPTION OF THE DRAWINGS

Through reading the detailed description of the following preferred embodiments, various other advantages and benefits will become apparent to an ordinary person skilled in the art. Accompanying drawings are merely included for the purpose of illustrating the preferred embodiments and should not be considered as limiting of the invention. Further, throughout the drawings, same elements are indicated by same reference numbers. In the drawings:

FIG. 1 schematically illustrates a webpage interface displayed on a screen of an electronic apparatus through an application;

FIG. 2 schematically illustrates a flow chart of a method for processing a touch operation of an electronic apparatus according to an embodiment of the disclosure;

FIG. 3 schematically illustrates a block diagram of a device for processing a touch operation of an electronic apparatus according to an embodiment of the disclosure;

FIG. 4 schematically illustrates a block diagram of an electronic apparatus for executing the method according the disclosure; and

FIG. 5 schematically illustrates a memory cell which is used to store and carry program codes for realizing the method according to the disclosure.

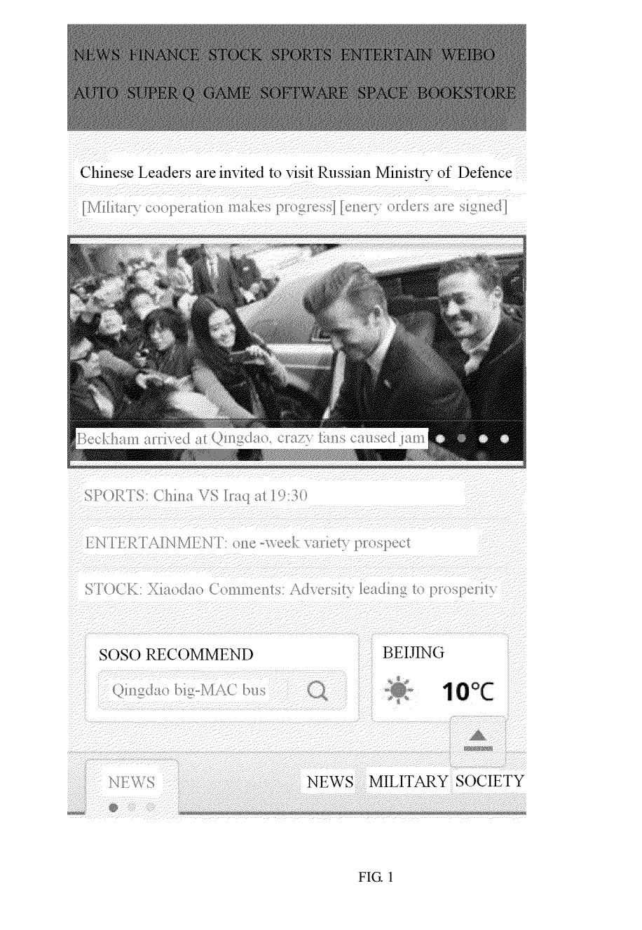

### DESCRIPTION OF THE EMBODIMENTS

Exemplary embodiments of the present disclosure will be described in detail with reference to the accompanying figures hereinafter. Although the exemplary embodiments of the disclosure are illustrated in the accompanying figures, it should be understood that the disclosure may be embodied in many different forms and should not be construed as being limited to the embodiments set forth herein. Rather, these embodiments are provided so that this disclosure will be understood thoroughly and completely and will fully convey the scope of the disclosure to those skilled in the art.

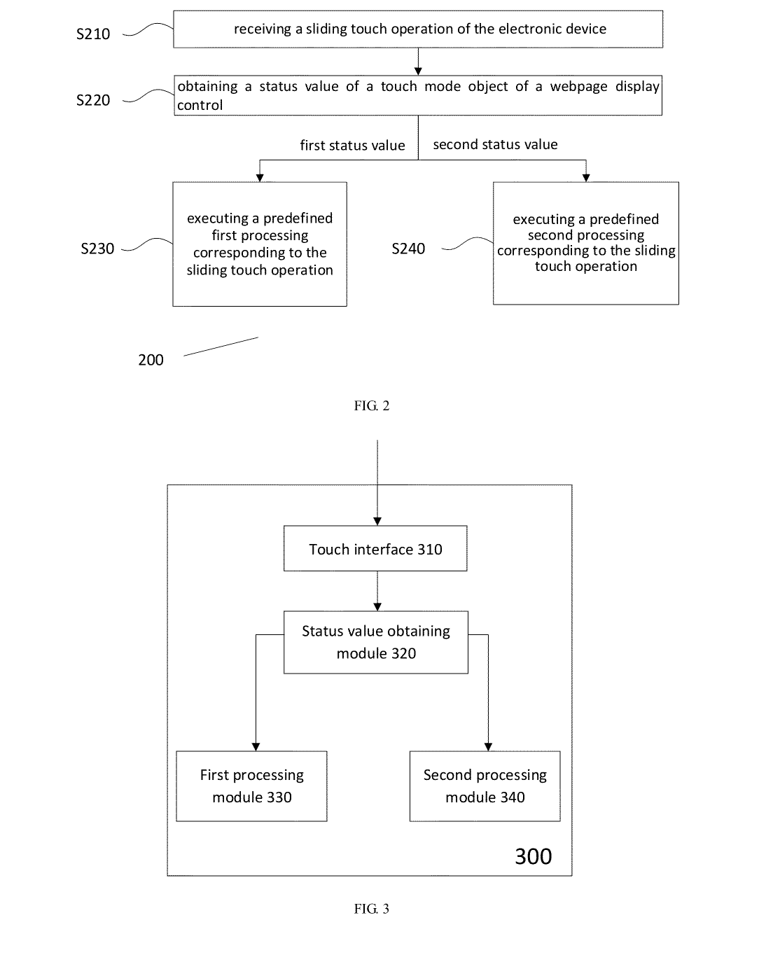

FIG. 2 schematically illustrates a flow chart of a method 200 for processing a touch operation of an electronic apparatus according to an embodiment of the disclosure.

The principle of the disclosure is applicable to any electronic apparatus having display unit, including but not limited to computer based on desktop operating system such as Windows, Linux, Mac OS and Unix; mobile phone, tablet, video player, e-book reader and digital photo frame based on mobile operating system such as iOS, Android, Windows Phone and Symbian. Hereinafter, the principle of the disclosure will be exemplarily described by way of an electronic apparatus with Android system for example. However, the specific example is provided merely for the illustrative purpose of the disclosure to help a reader understand the principle of the disclosure. The scope of the disclosure should not be limited thereto but could be applicable to any electronic apparatuses having display unit based on any operating systems.

As shown in FIG. 2, the method 200 for processing the touch operation of the electronic apparatus according to the embodiment of the disclosure starts from Step S210, which includes: receiving a sliding touch operation of the electronic apparatus. Optionally, the sliding touch operation can be completed by sliding on the touch screen of the electronic apparatus with the user's finger or other parts of the body or a contact device such as stylus. The electronic apparatus can receive such a sliding touch operation via its touch screen. According to the embodiment of the disclosure, the touch screen includes but is not limited to resistive touch screen, capacitive touch screen, piezoelectric touch screen, infrared touch screen, surface acoustic wave touch screen, etc,.

According to the embodiment of the disclosure, next, the method proceeds to Step S220, which includes: obtaining a status value of a touch mode object of a webpage display control. According to the embodiment of the disclosure, the webpage display control could be a WebView control of Android system and the touch mode object could be an mTouchMode object. For Android 4.0 and earlier versions, the webpage display control could be the WebView control; for Android 4.1 and higher versions, the webpage display control could be the WebView control with the use of projects of Java class WebViewClassic. It should be understood by those skilled in the art, above examples of the webpage display control and the touch mode object are provided merely to help a reader understand the principle of the disclosure rather than limiting the scope of the disclosure thereto. The webpage display control could be any controls capable of completing webpage display function, such as UIWebView control of iOS system, etc,.

For Android system, the WebView (or WebViewClassic) which is Java class maintains a private object called as mTouchMode. This object is used to record a current touch state of the WebView control. A status value of the mTouchMode object is determined by Android system according to operating modes of touch and contents within an operating region. The mTouchMode object may be assigned to following constants:
private static final int TOUCH_INIT_MODE=1;
private static final int TOUCH_DRAG_START_MODE=2;
private static final int TOUCH_DRAG_MODE=3;
private static final int TOUCH_SHORTPRESS_START_MODE=4;
private static final int TOUCH_SHORTPRESS_MODE=5;
private static final int TOUCH_DOUBLE_TAP_MODE=6;
private static final int TOUCH_DONE_MODE=7;
private static final int TOUCH_PINCH_DRAG=8;
private static final int TOUCH_DRAG_LAYER_MODE=9;

These constant values represent different meanings. For example, TOUCH_INIT_MODE represents a start status of a touch operation; TOUCH_PINCH_DRAG represents a pinch-action being performed by a user; rest of these will not be described herein one by one.

According to the embodiment of the disclosure, at Step S220, a Java reflex mechanism can be used to obtain the status value of the touch mode object of the webpage display control, and for example obtain the status value of the mTouchMode object of the WebView control or the status value of the mTouchMode object of the WebViewClassic used by the WebView control.

According to the embodiment of the disclosure, the reflex operation can be completed through a reflex mechanism provided for example by Java language, in which attribute of the mTouchMode object is temporarily changed from private attribute to public attribute for direct use and amendments. It should be understood by those skilled in the art, other programming languages (such as .Net language) can also be used in a similar manner to temporarily change the object attribute from the private attribute to the public attribute to complete the reflex operation.

Hereinafter, exemplary codes for obtaining the value of the mTouchMode object by using the Java reflex mechanism are as follows:

public static int getWebViewTouchMode(Object webView) {

try {

Field f = android.webkit.WebView.class.getDeclaredField(“mTouchMode”);
f.setAccessible(true);
return (Integer) f.get(webView);

} catch (Exception e) {
}
return −1;

}

It should be understood by those skilled in the art, above exemplary codes are provided merely to help a reader understand the principle of the disclosure rather than limiting the scope of the disclosure thereto.

According to the embodiment of the disclosure, the status value of the touch mode object (for example, mTouchMode object) is determined by the region where the sliding touch operation occurs, and different status values represent the sliding touch operation in different regions.

According to the embodiment of the disclosure, in the case that the sliding touch operation occurs in a region where the webpage contents cannot be dragged, the status value is the first status value; in contrast, in the case that the sliding touch operation occurs in a region where the webpage contents can be dragged, the status value is the second status value.

Optionally, the first status value could be TOUCH_DRAG_MODE, while the second status value could be TOUCH_INIT_MODE or TOUCH_DONE_MODE. However, described above are simply examples of the first status value and the second status value. According to different Android versions, the first status value and second status value can be varied.

By above characteristics of the status value of the touch mode object, the status value can be used as reference to execute a targeted processing.

According to the embodiment of the disclosure, in the case that the status value is first status value, the method can proceed to Step S230, which includes: executing a first processing. Optionally, the first processing could be a processing for a gesture operation corresponding to the sliding touch operation, for example, a processing for next-webpage or previous-webpage gesture operation, since the first status value represents that the sliding touch operation occurs in the region where the webpage contents cannot be dragged.

According to the embodiment of the disclosure, in the case that the status value is second status value, the method can proceed to Step S240, which includes: executing a second processing. Optionally, the second processing could be a processing for a dragging operation corresponding to the sliding touch operation, since the second status value represents that the sliding touch operation occurs in the region where the webpage contents can be dragged.

The disclosure provides above method for processing the touch operation of the electronic apparatus. According to the embodiment of the disclosure, it is possible to receive the sliding touch operation of the electronic apparatus and to obtain the status value of the touch mode object of the webpage display control; in the case that the status value is first status value, to execute the first processing; and in the case that the status value is second status value, to execute the second processing. Thereby, it is possible to exactly judge characteristics of a region (for example, whether it is a region where the webpage contents cannot be dragged or a region where the webpage contents can be dragged) according to the status value reflecting the region where the sliding touch operation occurs and to execute the processing corresponding to the region, so as to effectively eliminate the shortage that a processing is completed contrary to the purpose of the user's sliding touch operation since it is hard to distinguish regions in the page having different characteristics in the prior art. In the meanwhile, since there is no need to change a kernel component of a browser or other page display program, it is possible to directly use various characteristics of operating system having new version without re-development, while avoiding a security risk introduced by amending the kernel component. In addition, since there is no individual built-in kernel component, the memory space of the electronic apparatus can be saved.

Correspondingly to above method 200, there is also provided a device for processing a touch operation of an electronic apparatus. FIG. 3 schematically illustrates a block diagram of a device 300 for processing a touch operation of an electronic apparatus according to an embodiment of the disclosure.

As shown in FIG. 3, the device 300 may include a touch interface 310, a status value obtaining module 320, a first processing module 330 and a second processing module 340. Herein, the touch interface 310 is configurable to receive a sliding touch operation of the electronic apparatus; the status value obtaining module 320 is configurable to obtain a status value of a touch mode object of a webpage display control; the first processing module 330 is configurable to execute a first processing in the case that the status value is a first status value; the second processing module 340 is configurable to execute a second processing in the case that status value is a second status value.

First, the touch interface 310 can receive the sliding touch operation of the electronic apparatus. Optionally, the sliding touch operation can be completed by sliding on the touch screen of the electronic apparatus with the user's finger or other parts of the body or a contact device such as stylus. The touch interface 310 can receive such a sliding touch operation via the touch screen of the electronic apparatus. According to the embodiment of the disclosure, the touch screen includes but is not limited to resistive touch screen, capacitive touch screen, piezoelectric touch screen, infrared touch screen, surface acoustic wave touch screen, etc,.

According to the embodiment of the disclosure, next, the status value obtaining module 320 can obtain a status value of a touch mode object of a webpage display control. According to the embodiment of the disclosure, the webpage display control could be a WebView control of Android system and the touch mode object could be an mTouchMode object. For Android 4.0 and earlier versions, the webpage display control could be the WebView control; for Android 4.1 and higher versions, the webpage display control could be the WebView control with the use of projects of Java class WebViewClassic. It should be understood by those skilled in the art, above examples of the webpage display control and the touch mode object are provided merely to help a reader understand the principle of the disclosure rather than limiting the scope of the disclosure thereto. The webpage display control could be any controls capable of completing webpage display function, such as UIWebView control of iOS system, etc,.

For Android system, the WebView (or WebViewClassic) which is Java class maintains a private object called as mTouchMode. This object is used to record a current touch state of the WebView control. A status value of the mTouchMode object is determined by Android system according to operating modes of touch and contents within an operating region. The mTouchMode object may be assigned to following constants:
private static final int TOUCH_INIT_MODE=1;
private static final int TOUCH_DRAG_START_MODE=2;
private static final int TOUCH_DRAG_MODE=3;
private static final int TOUCH_SHORTPRESS_START_MODE=4;
private static final int TOUCH_SHORTPRESS_MODE=5;
private static final int TOUCH_DOUBLE_TAP_MODE=6;
private static final int TOUCH_DONE_MODE=7;
private static final int TOUCH_PINCH_DRAG=8;
private static final int TOUCH_DRAG_LAYER_MODE=9;

These constant values represent different meanings. For example, TOUCH_INIT_MODE represents a start status of a touch operation; TOUCH_PINCH_DRAG represents a pinch-action being performed by a user; rest of these will not be described herein one by one.

According to the embodiment of the disclosure, by a Java reflex mechanism, the status value obtaining module 320 can obtain the status value of the touch mode object of the webpage display control, and for example obtain the status value of the mTouchMode object of the WebView control or the status value of the mTouchMode object of the WebViewClassic used by the WebView control.

According to the embodiment of the disclosure, the status value obtaining module 320 can complete the reflex operation through a reflex mechanism provided for example by Java language, in which attribute of the mTouchMode object is temporarily changed from private attribute to public attribute for direct use and amendments. It should be understood by those skilled in the art, other programming languages (such as .Net language) can also be used in a similar manner to temporarily change the object attribute from the private attribute to the public attribute to complete the reflex operation.

Hereinafter, exemplary codes for obtaining the value of the mTouchMode object by using the Java reflex mechanism are as follows:

public static int getWebViewTouchMode(Object webView) {

try {

Field f = android.webkit.WebView.class.getDeclaredField(“mTouchMode”);
f.setAccessible(true);
return (Integer) f.get(webView);

} catch (Exception e) {
}
return −1;

}

It should be understood by those skilled in the art, above exemplary codes are provided merely to help a reader understand the principle of the disclosure rather than limiting the scope of the disclosure thereto.

According to the embodiment of the disclosure, the status value of the touch mode object (for example, mTouchMode object) is determined by the region where the sliding touch operation occurs, and different status values represent the sliding touch operation in different regions.

According to the embodiment of the disclosure, in the case that the sliding touch operation occurs in a region where the webpage contents cannot be dragged, the status value is the first status value; in contrast, in the case that the sliding touch operation occurs in a region where the webpage contents can be dragged, the status value is the second status value.

Optionally, the first status value could be TOUCH_DRAG_MODE, while the second status value could be TOUCH_INIT_MODE or TOUCH_DONE_MODE. However, described above are simply examples of the first status value and the second status value. According to different Android versions, the first status value and second status value can be varied.

By above characteristics of the status value of the touch mode object, the status value can be used as reference to execute a targeted processing.

According to the embodiment of the disclosure, in the case that the status value is first status value, the first processing module 330 can execute the first processing. Optionally, the first processing could be a processing for a gesture operation corresponding to the sliding touch operation, for example, a processing for next-webpage or previous-webpage gesture operation, since the first status value represents that the sliding touch operation occurs in the region where the webpage contents cannot be dragged.

According to the embodiment of the disclosure, in the case that the status value is second status value, the second processing module 340 can execute the second processing. Optionally, the second processing could be a processing for a dragging operation corresponding to the sliding touch operation, since the second status value represents that the sliding touch operation occurs in the region where the webpage contents can be dragged.

Since the various apparatus (device) embodiments as described above corresponds to the foregoing method embodiments, detailed description of the device embodiments will be omitted herein.

Algorithm and display provided herein are not inherently related to a particular computer, virtual system or other equipment. Various general systems may also be used with the teaching based on the disclosure. According to the above description, the required structure for constructing such a system is obvious. In addition, the disclosure is not directed to any particular programming language. It should be understood that a variety of programming languages can be used to implement the disclosed contents as described herein and above description to the particular programming language is to disclose the best inventive implementation mode.

Many details are discussed in the specification provided herein. However, it should be understood that the embodiments of the disclosure can be implemented without these specific details. In some examples, the well-known methods, structures and technologies are not shown in detail so as to avoid an unclear understanding of the description.

Similarly, it should be understood that, in order to simplify the disclosure and to facilitate the understanding of one or more of various aspects thereof, in the above description of the exemplary embodiments of the disclosure, various features of the disclosure may sometimes be grouped together into a single embodiment, accompanying figure or description thereof. However, the method of this disclosure should not be constructed as follows: the disclosure for which the protection is sought claims more features than those explicitly disclosed in each of claims. More specifically, as reflected in the following claims, the inventive aspect is in that the features therein are less than all features of a single embodiment as disclosed above. Therefore, claims following specific embodiments are definitely incorporated into the specific embodiments, wherein each of claims can be considered as a separate embodiment of the disclosure.

It should be understood by those skilled in the art that modules of the device in the embodiments can be adaptively modified and arranged in one or more devices different from the embodiment. Modules in the embodiment can be combined into one module, unit or component, and also can be divided into more sub-modules, sub-units or sub-components. Except that at least some of features and/or processes or modules are mutually exclusive, various combinations can be used to combine all the features disclosed in specification (including claims, abstract and accompanying figures) and all the processes or units of any methods or devices as disclosed herein. Unless otherwise definitely stated, each of features disclosed in specification (including claims, abstract and accompanying figures) may be taken place with an alternative feature having same, equivalent or similar purpose.

In addition, it should be understood by those skilled in the art, although some embodiments as discussed herein comprise some features included in other embodiment rather than other feature, combination of features in different embodiment means that the combination is within a scope of the disclosure and forms the different embodiment. For example, in the claims, any one of the embodiments for which the protection is sought can be used in any combination manner.

Each of devices according to the embodiments of the disclosure can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the modules in the device according to the embodiments of the disclosure. The disclosure may further be implemented as device program (for example, computer program and computer program product) for executing some or all of the methods as described herein. Such program for implementing the disclosure may be stored in the computer readable medium, or have a form of one or more signals. Such a signal may be downloaded from the internet websites, or be provided in carrier, or be provided in other manners.

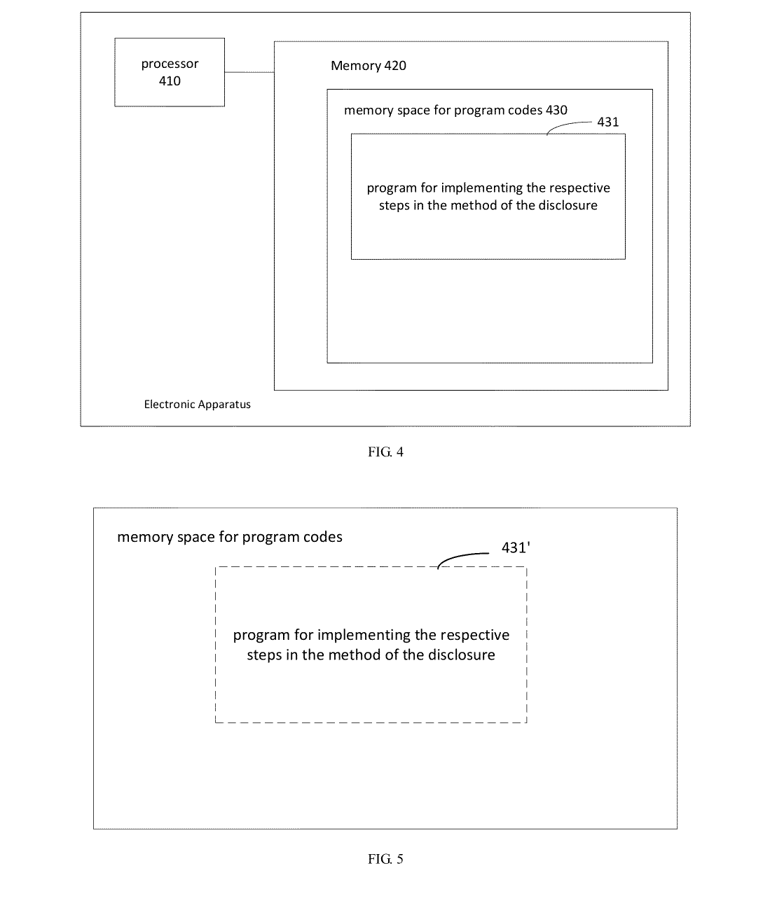

For example, FIG. 4 illustrates a block diagram of an electronic apparatus for executing the method according the disclosure. Traditionally, the electronic apparatus includes a processor 410 and a computer program product or a computer readable medium in form of a memory 420. The memory 420 could be electronic memories such as flash memory, EEPROM (Electrically Erasable Programmable Read-Only Memory), EPROM, hard disk or ROM. The memory 420 has a memory space 430 for executing program codes 431 of any steps in the above methods. For example, the memory space 430 for program codes may include respective program codes 431 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 5. The memory cells may be provided with memory sections, memory spaces, etc., similar to the memory 420 of the server as shown in FIG. 4. The program codes may be compressed for example in an appropriate form. Usually, the memory cell includes computer readable codes 431′ which can be read for example by processors 410. When these codes are operated on the server, the server may execute respective steps in the method as described above.

The “an embodiment”, “embodiments” or “one or more embodiments” mentioned in the disclosure means that the specific features, structures or performances described in combination with the embodiment(s) would be included in at least one embodiment of the disclosure. Moreover, it should be noted that, the wording “in an embodiment” herein may not necessarily refer to the same embodiment.

Many details are discussed in the specification provided herein. However, it should be understood that the embodiments of the disclosure can be implemented without these specific details. In some examples, the well-known methods, structures and technologies are not shown in detail so as to avoid an unclear understanding of the description.

It should be noted that the above-described embodiments are intended to illustrate but not to limit the disclosure, and alternative embodiments can be devised by the person skilled in the art without departing from the scope of claims as appended. In the claims, any reference symbols between brackets form no limit of the claims. The wording “include” does not exclude the presence of elements or steps not listed in a claim. The wording “a” or “an” in front of an element does not exclude the presence of a plurality of such elements. The disclosure may be realized by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings can be interpreted as a name.

Also, it should be noticed that the language used in the present specification is chosen for the purpose of readability and teaching, rather than explaining or defining the subject matter of the disclosure. Therefore, it is obvious for an ordinary skilled person in the art that modifications and variations could be made without departing from the scope and spirit of the claims as appended. For the scope of the disclosure, the publication of the inventive disclosure is illustrative rather than restrictive, and the scope of the disclosure is defined by the appended claims.

1. A method for processing a touch operation of an electronic apparatus, comprising:
receiving a sliding touch operation of the electronic apparatus;
obtaining a status value of a touch mode object of a webpage display control;
executing a first processing in the case that the status value is a first status value; and
executing a second processing in the case that the status value is a second status value.

2. The method according to claim 1, wherein in the obtaining a status value of a touch mode object of a webpage display control, a Java reflex mechanism is used to obtain the status value of the touch mode object of the webpage display control.

3. The method according to claim 1, wherein the status value is determined by a region where the sliding touch operation occurs.

4. The method according to claim 1, wherein the webpage display control is a WebView control of Android system, and the touch mode object is an mTouchMode object.

5. The method according to claim 4, wherein the first status value is TOUCH_DRAG_MODE, and the second status value is TOUCH_INIT_MODE or TOUCH_DONE_MODE.

6. The method according to claim 5, wherein in the case that the sliding touch operation occurs in a region where the webpage contents are non-draggable, the status value is the first status value; and in the case that the sliding touch operation occurs in a region where the webpage contents are draggable, the status value is the second status value.

7. The method according to claim 1, wherein the first processing is a processing for a gesture operation corresponding to the sliding touch operation, and the second processing is a processing for a dragging operation corresponding to the sliding touch operation.

8. An electronic apparatus for processing a touch operation, comprising:
a memory having instructions stored thereon;
a processor configured to execute the instructions to perform operations for processing a touch operation, comprising:
a touch interface, configurable to receiving a sliding touch operation of the electronic apparatus;
obtaining a status value of a touch mode object of a webpage display control;
executing a first processing in the case that the status value is a first status value; and
executing a second processing in the case that status value is a second status value.

9. The electronic apparatus according to claim 8, wherein in the obtaining a status value of a touch mode object of a webpage display control, the status value of the touch mode object of the webpage display control is obtained through a Java reflex mechanism.

10. The electronic apparatus according to claim 8, wherein the status value is determined by a region where the sliding touch operation occurs.

11. The electronic apparatus according to claim 8, wherein the webpage display control is a WebView control of Android system, and the touch mode object is an mTouchMode object.

12. The electronic apparatus according to claim 11, wherein the first status value is TOUCH_DRAG_MODE, and the second status value is TOUCH_INIT_MODE or TOUCH_DONE_MODE.

13. The electronic apparatus according to claim 12, wherein in the case that the sliding touch operation occurs in a region where the webpage contents are non-draggable, the status value is the first status value; and in the case that the sliding touch operation occurs in a region where the webpage contents are draggable, the status value is the second status value.

14. The electronic apparatus according to claim 8, wherein in the executing a first processing in the case that the status value is a first status value, a processing for a gesture operation corresponding to the sliding touch operation is executed in the case that the status value is the first status value, and in the executing a second processing in the case that the status value is a second status value, a processing for a dragging operation corresponding to the sliding touch operation is executed in the case that the status value is the second status value.

15. (canceled)

16. A non-transitory computer readable medium, having computer programs stored theron that, when executed by one or more processors of an electronic apparatus, cause the electronic apparatus to perform:
receiving a sliding touch operation of the electronic apparatus;
obtaining a status value of a touch mode object of a webpage display control;
executing a first processing in the case that the status value is a first status value; and
executing a second processing in the case that the status value is a second status value.
